(19) United States
(12) Patent Application Publication
(10) Pub. No.: US 2006/0173826 A1
(43) Pub. Date: Aug. 3, 2006

(54) Methods and systems for address-related information viewing

(76) Inventors: Oliver D. Crawford, Collierville, TN (US); Lee S. Powell, Bartlett, TN (US); Ruth A. Jones, Collierville, TN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/213,791

(22) Filed: Aug. 30, 2005

Related U.S. Application Data
(60) Provisional application No. 60/606,901, filed on Sep. 3, 2004.

(51) Int. Cl. G06F 17/30

(52) U.S. Cl. 707/3

(57) ABSTRACT

Systems and methods are disclosed for providing address-related information. The system may comprise a memory storage device containing the address-related information and an application program and a processing unit coupled to the memory storage device, wherein the processing unit is operative to: submit a query to the memory device to retrieve address-related information that is responsive to the query, and display the address-related information to a user. The method may comprise the stages of loading the address-related information and an application program into a processor, receiving a query at the processor, utilizing search tools to find address-related information responsive to the query, and displaying the address-related information responsive to the query.

### BACKGROUND

This application claims priority to U.S. Provisional Application No. 60/606,901 filed on Sep. 3, 2004, the contents of which are expressly incorporated herein by reference.

### TECHNICAL FIELD

The present invention generally relates to methods and systems for information retrieval. More particularly, the present invention relates to the retrieval of address-related information using an address information system (“AIS”).

### BACKGROUND

Currently, address related information is distributed in the form of hard copy reports. These hard copy reports, which may contain many pages, are cumbersome and expensive for not only a support center to produce, but also for its customers to purchase and use. The production and distribution of these reports becomes particularly cumbersome because the reports are distributed to users on a periodic basis; therefore, the reports must be repeatedly updated and distributed.

Once a customer receives the hardcopy version of this data, the customer must then search through the voluminous pages of data to find the specific information that is pertinent for the task at hand. For example, the customer may have to wade through the pages of a hard copy report to find the ZIP Code information for a particular address or find the delivery types available for a particular geographic region.

Methods, systems, and articles of manufacture consistent with certain embodiments will be disclosed herein to solve one or more of the problems set forth above.

### SUMMARY

Systems and methods are disclosed for providing address-related information. The system may comprise a memory storage device containing the address-related information and an application program and a processing unit coupled to the memory storage device. The processing unit is operative to submit a query to the memory device to retrieve address-related information that is responsive to the query and display the address-related information to a user.

In one embodiment, a method may be provided for utilizing address-related information. The method may comprise loading the address-related information and an application program into a processor, receiving a query with the processor, utilizing search tools to find address-related information responsive to the query, and displaying the address-related information that is responsive to the query.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary computer system in which the principles of the present invention may be implemented, consistent with the present invention.

FIG. 2 is a diagram of another embodiment of a system consistent with the principles of the present invention.

FIG. 3 is a flow chart of an exemplary method for providing address-related information and one or more application programs to be used consistent with the principles of the present invention.

FIG. 4 is a flow chart of an exemplary method for utilizing address-related information and one or more application program, consistent with the principles of the present invention.

FIG. 5 is a diagram of another embodiment of a system consistent with the principles of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention provide means for users to search, lookup, browse, and print data from several data sources. The ability to print hardcopy reports locally at a user's site on demand may be a particularly important function. Users may also have the ability to perform individual ZIP+4™ address lookups on any address in a national database. The combination of address-related information and search capabilities on a computer-readable medium may increase efficiency of delivery and updating of data and decrease production costs.

One embodiment consistent with the invention may comprise a system for providing an electronic suite of products that may provide a user with the tools to accommodate various data searches and a user's mailing needs in a more expedient manner. This system may allow the user to individually purchase and activate the product(s) provided by the system without receiving updated system software.

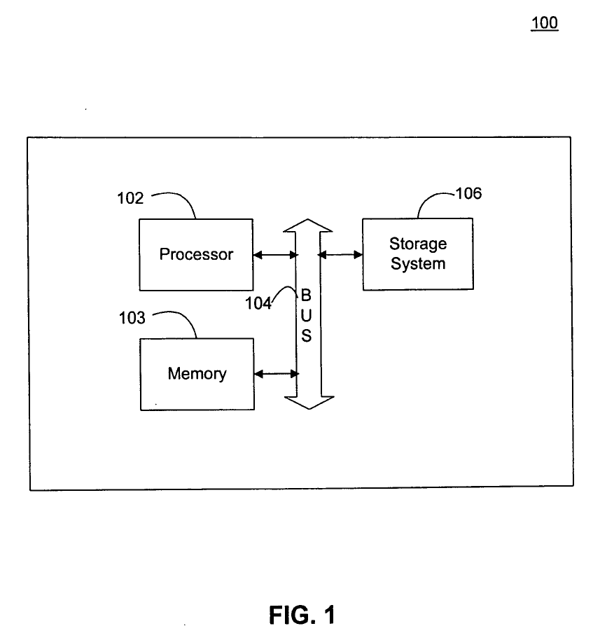

The system may comprise a memory storage device coupled to a processing unit. The processing unit may be operative to retrieve data from the memory storage device and display the data based upon a user's request. Consistent with an embodiment of the present invention, the aforementioned memory, processing unit, and other components may be implemented in a computer system, such as the exemplary computer system 100 of FIG. 1.

By way of a non-limiting example, FIG. 1 illustrates system 100 in which the features and principles of the present invention may be implemented. As illustrated in the block diagram of FIG. 1, system 100 may contain components such as a processor 102, a memory 103 (e.g. RAM), and a bus 104, which couples processor 102 and memory 103 to a storage system 106. Storage system 106 may include one or more memory devices (e.g. RAM, ROM, NV RAM, FLASH, magnetic disks, optical storage disks, etc.). Additionally, storage system 106 may include memory controller components, such as an I/O controller that facilitates access to and from storage system 106. In one embodiment, storage system 106 may store the address information. This information may be accessed by processor 102 to perform one or more processes consistent with certain disclosed embodiments.

Any suitable combination of hardware, software and/or firmware may be used to implement the memory, processing unit, or other components. The aforementioned system and processor are exemplary and other systems and processors may comprise the aforementioned memory, processing unit, or other components, consistent with embodiments of the present invention.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

System 100 may be implemented using a personal or portable computer, network computer, mainframe, or other similar microcomputer-based workstation. The processor may comprise any type of computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. The aforementioned systems and devices are exemplary and the processor may comprise other systems or devices.

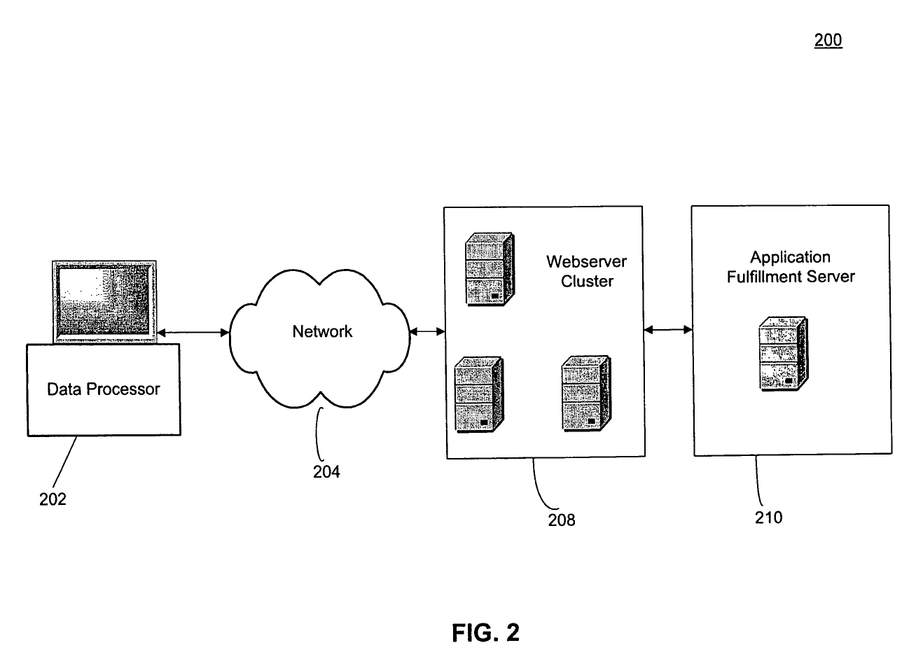

FIG. 2 shows another embodiment in accordance with the principles of the present invention. A system 200 may include data processor 202, a network 204, a web server cluster 208, and an application fulfillment server 210. In this embodiment, processor 202 may include a suite of application programs that a user may use to search, lookup, browse, and print data address-related information. The address-related information may be updated using network 204, web server cluster 208, or application fulfillment server 210.

Data processor 202 may be implemented using a personal or portable computer, network computer, mainframe, or other similar microcomputer-based workstation. The processors may comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. The aforementioned systems and devices are exemplary and the processor may comprise other systems or devices.

In updating the address-related information, data processor 202 may send a request to network 204, which then forwards the request to web server cluster 208. Web cluster 208 may be used to host a web site for processing data update requests. Once web cluster 208 receives the request, a request may be forwarded to application fulfillment server 210. At some point after application fulfillment server 210 receives the forwarded request, application fulfillment server 210 may retrieve and transfer updated data to web cluster 208, which may in turn transfer the updated data through network 204 to data processor 202.

In some embodiments, network 204 may comprise, for example, a local area network (LAN) or a wide area network (WAN). Such networking environments are commonplace in offices, enterprise-wide computer networks, intranets, and the Internet, and are known by those skilled in the art. When a LAN is used as network 204, a network interface located at any of the processors may be used to interconnect any of the processors. When network 204 is implemented in a WAN networking environment, such as the Internet, the processors may typically include an internal or external modem (not shown) or other means for establishing communications over the WAN. Further, in utilizing network 204, data sent over network 204 may be encrypted to insure data security by using known encryption/decryption techniques.

In addition to utilizing a wire line communications system as network 204, a wireless communications system, or a combination of wire line and wireless may be utilized as network 204 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 200 may also transmit data by methods and processes other than, or in combination with, network 204. These methods and processes may include, but are not limited to, transferring data via, diskette, CD ROM, or any other type of electronic communication means.

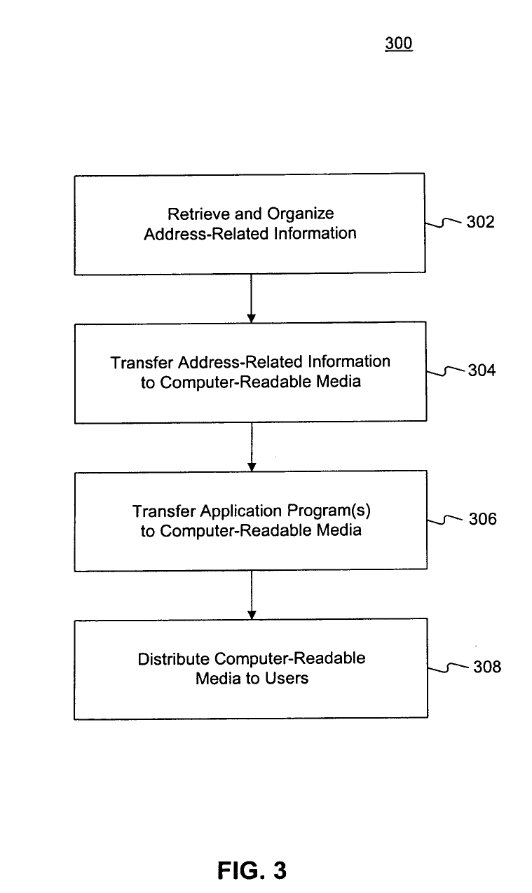

FIG. 3 is a flow chart setting forth an exemplary method 300 for providing address-related information and one or more application programs that may be used in conjunction with the address-related information. Exemplary method 300 may begin by retrieving and organizing the address-related information (Stage 302). Then, the address-related information may be transferred to a computer-readable media (Stage 304).

In addition to the address-related information, one or more application programs may also be transferred to the computer-readable media (Stage 306). Once the application program(s) and address-related information are on the computer-readable media, the computer readable media may be distributed to users (Stage 308). The application program(s) may be used to search, lookup, browse, and print data. For example, the application programs may provide reports for city/state/delivery type, county name, delivery statistics, ZIP+4™ retrieval, and address lookup. These reports and search features may allow users to obtain address-related information, such as the post office, carrier route number, delivery point code, and check digit information that may be associated with an address.

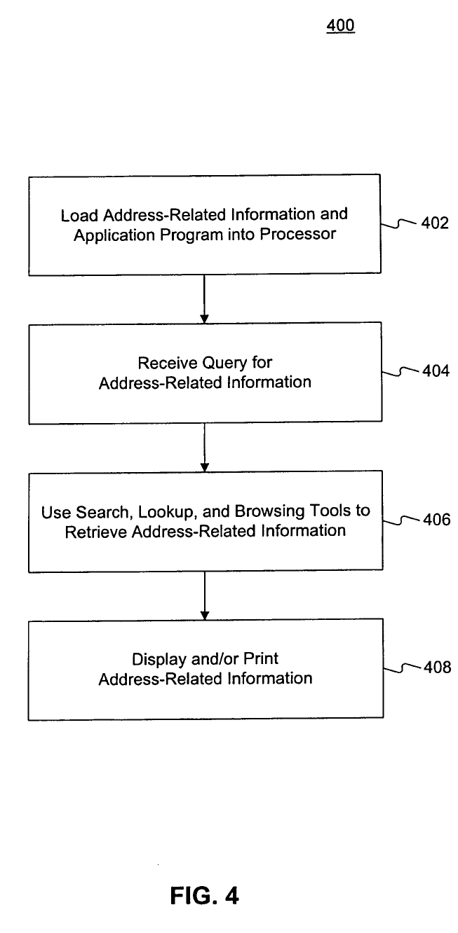

FIG. 4 is a flow chart setting forth an exemplary method 400 for utilizing address-related information and one or more application programs that may be used in conjunction with the address-related information. Exemplary method 400 may begin by loading the address-related information and the application program(s) into a processor (Stage 402). Once the address-related information and application program(s) are loaded, the processor may receive a query to retrieve address-related information that may be associated with a particular mailing function (Stage 404).

In response to the query, the processor may use search, lookup, or browsing functions to retrieve the address-related information responsive to the query (Stage 406). The retrieved address-related information may be displayed and/or printed upon demand.

Appendix A of U.S. Provisional Patent Application No. 60/606,901 filed on Sep. 3, 2004 relates to an exemplary embodiment of a system consistent with the principles of the present invention. In that embodiment, an Address Information System (“AIS”) Viewer portable media, such as a CD-ROM, is distributed regularly, such as monthly.

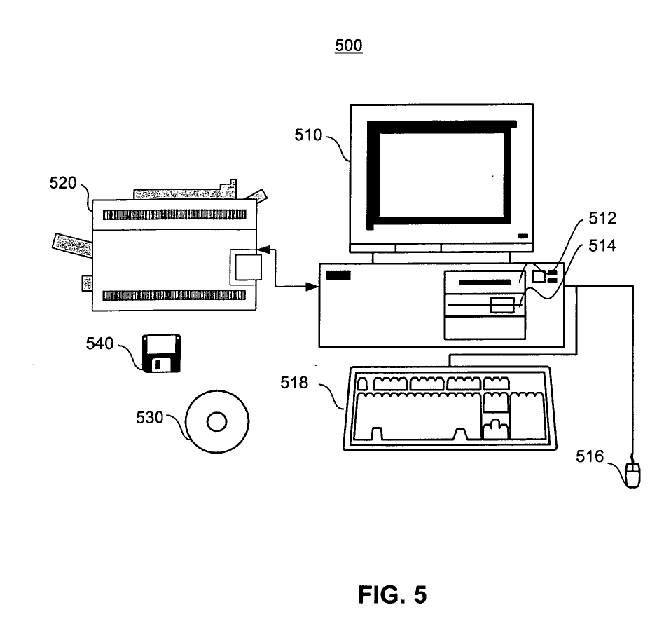

FIG. 5 is a diagram of another embodiment of a system 500 consistent with the principles of the present invention. A personal computer 510 includes a magnetic disk drive 512 for a magnetic storage disk, such as floppy disk 540, and an optical disk drive 514, for an optical storage disk, such as a CD 530. A user inputs commands to the personal computer 510 through a mouse 516 and a keyboard 518. The personal computer 510 may or may not be connected to a network such as a LAN, WAN, or the Internet. A printer 520 connects to the personal computer 510.

A user receives the AIS Viewer application program and address related information stored on the CD 530. Alternatively, the user may receive the AIS Viewer application program and address related information stored on a different media, such as floppy disk 540 or a FLASH memory, or through a network. The CD 530 may be distributed through a delivery service such as the U.S. mail.

The user inserts the CD 530 into the optical disk drive 514 and executes the application program on the CD 530. The AIS Viewer Manager then appears on the display screen of the personal computer 510. Continuing the installation may require a client key available from the distributor of the CD 530. According to one embodiment, the client key enables the AIS Viewer application program and sets the number of days the program is accessible.

In this embodiment, the AIS Viewer generates reports, such as Address Lookup, City/State/Delivery Type Retrieval, Country Name Retrieval, Delivery Statistics Retrieval, and ZIP+4™ Retrieval. An optional sort routine is available to resort the output.

The Address Lookup Report provides a ZIP+4™ number for an individual address as well as a carrier route number, country number, delivery point code, and check digit.

The City/State/Delivery Type Retrieval Report may provide a comprehensive list of ZIP Codes™ and the city, country, and post office names associated with those ZIP Codes™. Such a report might be used to validate the city name and ZIP Code™ of a mailing address. When searching, lookup options may include: city, state, city and state, city finance number, ZIP Code™, and delivery type.

The ZIP+4™ Retrieval Report may provide specific data or individual street information. A user can search for a specific street name or all streets by: street and ZIP Code™; street, city, and state; city and state; or ZIP Code™.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing address-related information, the method comprising:
retrieving address-related information;
transferring the address-related information and an application program to a computer-readable media; and
distributing the computer-readable media.

2. The method as claimed in claim 1, wherein the computer readable media comprises an optical disk.

3. The method as claimed in claim 2, wherein the optical disk is distributed through a mail delivery service.

4. The method as claimed in claim 1, wherein the computer readable media comprises a magnetic disk.

5. The method as claimed in claim 1, wherein the computer readable media comprises a solid state memory.

6. The method as claimed in claim 1, wherein the address-related information includes listings of cities and states.

7. The method as claimed in claim 6, wherein the address related information further includes ZIP Code™ information.

8. A method for utilizing address-related information, the method comprising:
loading the address-related information and an application program into a processor;
receiving a query with the processor;
utilizing search tools from the application program to find address-related information responsive to the query; and
displaying the address-related information responsive to the query.

9. The method as claimed in claim 8, further comprising the step of receiving the address related information on a computer readable media.

10. The method as claimed in claim 9, wherein the computer readable media comprises an optical disk.

11. The method as claimed in claim 9, wherein the computer readable media comprises a magnetic disk.

12. The method as claimed in claim 9, wherein the computer readable media comprises a solid state memory.

13. The method as claimed in claim 8, wherein loading the address-related information and an application program into a processor comprises entering a client key.

14. The method as claimed in claim 8, further comprising generating a report of the address related information using the application program.

15. The method as claimed in claim 14, wherein the report is selected from the group of reports consisting of address lookup, city/state/delivery type retrieval, country name retrieval, delivery statistics retrieval, and ZIP+4™ information retrieval.

16. A system for providing address-related information, the system comprising:
a memory storage device containing the address-related information and an application program; and
a processing unit coupled to the memory storage device and executing the application program, wherein the processing unit under the control of the application program is operative to:
receive a query;
in response to the query, retrieve address-related information responsive to the query; and
display the retrieved location-related information to a user.

17. The system as claimed in claim 16, wherein the memory storage device comprises an optical disk drive and an optical disk.

18. The system as claimed in claim 16, wherein the memory storage device comprises a magnetic tape drive and a magnetic tape.

19. The system as claimed in claim 16, wherein the memory storage device comprises a magnetic disk drive and a magnetic disk.

20. The system as claimed in claim 16, wherein the memory storage device comprises a solid state memory.
